(19) United States
(12) Patent Application Publication
(10) Pub. No.: US 2012/0087207 A1
(43) Pub. Date: Apr. 12, 2012

(54) PROCESSING SEISMIC DATA

(75) Inventors: Clement Kostov, Montigny le Bretonneux (FR); Jon-Fredrik Hopperstad, Cambridge (GB); Philip Kitchenside, Kent (GB); Johan Olof Anders Robertsson, Cambridge (GB)

(73) Assignee: WesternGeco LLC, Houston, TX (US)

(21) Appl. No.: 13/259,546

(22) PCT Filed: Feb. 19, 2010
(86) PCT No.: PCT/IB10/00343

§ 371 Date: Dec. 16, 2011

(30) Foreign Application Priority Data
Mar. 27, 2009 (GB) 0905260.6

(51) Int. Cl. G01V 1/38

(52) U.S. Cl. 367/20; 367/21

(57) ABSTRACT

A method of monitoring a marine seismic source array comprises, consequent to actuation of a seismic source array (14), making a near-field measurement of seismic energy emitted by the seismic source array (14), using at least one near field sensor (15) and also acquiring seismic data using at least one seismic receiver (18). The far-field signature of the source array at one or more of the receiver location(s) is estimated from the near-field measurements of the emitted seismic energy, and this is compared with seismic data acquired at the receiver(s). This provides an indication of whether the source array and the method for predicting far-field signatures are operating correctly.

### BACKGROUND OF THE DISCLOSURE

The present invention relates to seismic surveying. In particular, it relates to a method of and system for seismic surveying which allows the monitoring of a seismic source array.

The principle of seismic surveying is that a source of seismic energy is caused to emit seismic energy such that it propagates downwardly through the earth. The downwardly-propagating seismic energy is reflected by one or more geological structures within the earth that act as partial reflectors of seismic energy. The reflected seismic energy is detected by one or more sensors (generally referred to as “receivers”). It is possible to obtain information about the geological structure of the earth from seismic energy that undergoes reflection within the earth and is subsequently acquired at the receivers.

When a seismic source array is actuated to emit seismic energy it emits seismic energy over a defined period of time. The emitted seismic energy from a seismic source array is not at a single (temporal) frequency but contains components over a range of frequencies. The amplitude of the emitted seismic energy is not constant over the emitted frequency range, but is frequency dependent. The emitted seismic energy from a seismic source array may also vary in space due to two factors: the source array may emit different amounts of energy in different directions, and the seismic wavefronts may “expand” with time (expanding spherical waves as opposed to plane waves). The seismic wavefield emitted by a seismic source array is known as the “signature” of the source array. When seismic data are processed, knowledge of the signature of the seismic source array used is desirable, since this allows more accurate identification of events in the seismic data that arise from geological structures within the earth. In simple mathematical terms, the seismic wavefield acquired at a receiver is the convolution operation of two factors; one representative of the earth's structure, and another representative of the wavefield emitted by the source array. The more accurate is the knowledge of the source array's signature, the more accurately the earth model may be recovered from the acquired seismic data.

A manufacturer of a seismic source may provide a general source signature for the seismic source. However, each time that a seismic source is actuated the actual emitted wavefield may vary slightly from the theoretical source signature. In a typical seismic survey a seismic source array is actuated repeatedly and seismic data are acquired consequent to each actuation of the source array. Each actuation of the source array is known as a “shot”. In processing seismic data it is desirable to know to what extent a difference between the trace acquired for one shot and a trace acquired for another shot is a consequence of a difference in the source signatures for the two shots.

It has been suggested that one or more “near-field sensors” may be positioned close to a seismic source, in order to record the source signature. By positioning the near-field sensors(s) close to the seismic source the wavefield acquired by the near-field sensors should be a reliable measurement of the emitted source wavefield. WesternGeco's Trisor/CMS system provides estimates of the source wavefield from measurements with near-field hydrophones near each of the seismic sources composing the source arrays in marine seismic surveys. These estimates have been used to control the quality and repeatability of the emitted signals, and to perform compensation for shot-to-shot variations or source-array directivity. Recent comparison of signals, predicted by the Trisor/CMS system or recorded with point-receiver hydrophones (Q-marine system), indicate that the quality of the Trisor/CMS estimates is excellent over a large band of frequencies and source take-off angles.

FIG. 1 shows a comparison between a Trisor/CMS predicted incident wavefield (a) and an incident wavefield measured with a near-field hydrophone on a Q-marine streamer, towed 19 m deeper than the source array (the depth of the sources is 4 m and the receivers are at a depth of 23 m) and about 100 m behind the source array (b). FIG. 1 shows the pressure in millibars (mbar) against time in seconds. The waveforms have been bandlimited to a range of frequencies between 1 and 120 Hz. It can be seen that the agreement between the two waveforms is very good over this range of frequencies. Note that the energy is propagating to the near-field hydrophone following a nearly horizontal raypath corresponding to a take-off (dip) angle of 80 degrees, measured in a vertical plane. (In 3D space, the definition of a take-off direction requires two angles. These two angles could be given as an angle in a vertical plane (take-off angle or dip angle) and an angle in a horizontal plane (azimuth angle).

Here, the take-off dip angle is defined as zero degrees in the vertical direction, and 90 degrees in the horizontal direction.)

The Trisor/CMS incident wavefield is the result of a computation involving several measurements or estimated quantities and some assumptions, as described for instance in Ziolkowski, A. et al., “The signature of an air gun array: Computation from near-field measurements including interactions” (1982). The key factors influencing the estimation are the position data for the guns and near-field hydrophones: as well as the estimate of the free surface reflection coefficient.

It has also been proposed to position a seismic sensor, or a plurality of seismic sensors (for example, arranged as a “ministreamer”), below a seismic source array, to determine the actual wavefield that is emitted when the source array is actuated. A significant change in the signature of a source array during a seismic survey could indicate that the source array was malfunctioning, and monitoring the output wavefield of the source array during data acquisition allows possible malfunctions of the source array to be detected as soon as possible.

The signature of a seismic source array is generally directional, even though the individual sources may behave as “point sources” that emit a wavefield that is spherically symmetrical. This is a consequence of the seismic source array generally having dimensions that are comparable to the wavelength of sound generated by the array.

The signature of a seismic source array further varies with distance from the array. This is described with reference to FIG. 2. An array of sources 3, in this example a marine source array positioned at a shallow depth below a water surface 4, emits seismic energy denoted as arrows 5. In FIG. 2 a “near field” region 6 is shown bounded by a boundary 7 with a “far-field” region 8 on the other side of the boundary. In the far-field, the signatures of standard seismic arrays are well approximated with a model assuming a non-isotropic point source. The amplitude decay for such signatures is inversely proportional to the distance from the source array. The notional boundary 7 separating the near field region 6 from the far-field region 8 is located at a distance from the source array approximately given by D²/λ, where D is the dimension of the array and λ is the wavelength. (For the example of FIG. 1, the data were acquired using a source array with an array dimension of 15 m. The wavelength at 75 Hz is 20 m (velocity of sound in water of 1500 m/s divided by 75 Hz), hence at 75 Hz the far-field region extends beyond 225/20 m e.g. beyond about 10 m from the source array. Since the receiver was approximately 100 m away from the source, the receiver is well within the far-field by this definition, even for frequencies up to 200 Hz.

In processing geophysical data, knowledge of the far-field signature of the source array is desirable, since most geological features of interest are located in the far-field region 8. Direct measurement of the far-field signature of the array, or the far-field signature of one of the individual guns of the array, is difficult, however, even when measuring the far-field signature in the water layer. For instance, one would have to ensure that no reflected energy is received during the measurement of the far-field signature or, if reflected energy is received, that a method exists to separate the reflected energy. Another complication for direct measurements is that the signature depends on the take-off direction.

The near-field signature of an individual seismic source may in principle be measured, for example in laboratory tests or in field experiments. However, knowledge of the source signatures of individual seismic sources is not sufficient to enable the far-field signature of a source array to be determined, since the sources of an array do not behave independently from one another.

Interactions between the individual sources of a seismic source array were considered in U.S. Pat. No. 4,476,553. The analysis specifically considered airguns, which are the most common seismic source used in marine surveying, although the principles apply to all marine seismic sources. An airgun has a chamber which, in use, is charged with air at a high pressure and is then opened. The escaping air generates a bubble which rapidly expands and then oscillates in size, with the oscillating bubble acting as a generator of a seismic wave. In the model of operation of a single airgun it is assumed that the hydrostatic pressure of the water surrounding the bubble is constant, and this is a reasonable assumption since the movement of the bubble towards the surface of the water is very slow. If a second airgun is discharged in the vicinity of a first airgun, however, it can no longer be assumed that the pressure surrounding the bubble generated by the first airgun is constant since the bubble generated by the first airgun will experience a seismic wave generated by the second airgun (and vice versa).

U.S. Pat. No. 4,476,553 proposed that, in the case of seismic source array containing two or more seismic sources, each seismic source could be represented by a notional near-field signature. In the example above of an array of two airguns, the pressure variations caused by the second airgun is absorbed into the notional signature of the first airgun, and vice versa, and the two airguns may be represented as two independent airguns having their respective notional signatures. The far-field signature of the array may then be found, at any desired point, from the notional signatures of the two airguns.

In general terms, U.S. Pat. No. 4,476,553, the contents of which are hereby incorporated by reference, discloses a method for calculating the respective notional signatures for the individual seismic sources in an array of n sources, from measurements of the near-field wavefield made at n independent locations. The required inputs for the method of U.S. Pat. No. 4,476,553 are:
measurements of the near-field wavefield at n independent locations;
the sensitivities of the n near-field sensors used to obtain the n measurements of the near-field wavefield; and
the (relative) positions of the n sources and the n near-field sensors.

For the simple source array containing two seismic sources 9,10 shown in FIG. 3, notional signatures for the two sources may be calculated according to the method of U.S. Pat. No. 4,476,553 from measurements made by near-field sensors 11,12 at two independent location from the distances a₁₁, a₁₂ between the location of the first near-field measuring sensor 12 and the seismic sources 9,10, from the distances a₂₁, a₂₂ between the location of the second near-field sensor 11 and the seismic sources 9, 10, and from the sensitivities of the two near-field sensors. (In some source arrays the near-field sensors are rigidly mounted with respect to their respective sources, so that the distances a₁₁ and a₂₂ are known.) Once the notional signatures have been calculated, they may be used to determine the signature of the source array at a third location 12, provided that the distances a₃₁, a₃₂ between the third location and the seismic sources 9,10 are known.

If a source array is not rigid it is necessary to obtain information about the positions of the seismic sources within the array before the method of U.S. Pat. No. 4,476,553 may be used. (For example, if the source array of FIG. 3 is not rigid the distances a₁₂, a₂₁ are not fixed and so must be determined.) This may be done by providing an external system for monitoring the positions of the sources in an array, for example by mounting GPS receivers on the source floats and placing depth sensors on the sources.

Determination of a notional source according to the method of U.S. Pat. No. 4,476,553 ignores the effect of any component of the wavefield reflected from the sea bed and so is limited to application in deep water seismography. The method of U.S. Pat. No. 4,476,553 has been extended in GB Patent No. 2 433 594 to use “virtual sources” so as to take account of reflections at the sea-surface or at the sea bottom.

### BRIEF SUMMARY OF THE DISCLOSURE

A first aspect of the present invention provides a method of monitoring a marine seismic source array, comprising:

a) consequent to actuation of the seismic source array, (i) measuring seismic energy emitted by the source array, using at least one near field sensor and (ii) acquiring seismic data using at least one seismic receiver;

b) predicting the far-field signature of the source array at one or more of the receiver location(s) from the seismic energy measured by the near-field sensor(s); and

c) for one or more of the receivers, comparing the predicted far-field signature at the receiver location with seismic data acquired at the receiver.

The present invention makes use of the seismic receivers that are provided in a seismic survey for acquiring seismic data in order to monitor the actual wavefield that is emitted by the source array. In the prior art approach in which one or more additional receivers are provided below the source array to determine the actual emitted wavefield, the additional receivers are -provided solely to monitor the output wavefield and are not used to acquire seismic data from which information about the earth's interior may be obtained. The present invention in contrast does not require any further equipment to be provided in the seismic survey.

Furthermore, the inventors have realised that the prior art approach in which one or more additional receivers are provided below the source array to determine the actual emitted wavefield suffers from the disadvantage that the position of the additional receiver(s) is not exactly known. While it is intended that the additional receiver(s) are positioned vertically below the source array, the action of towing the source array through the water, influenced by the speed of the boat and the currents in the water, means that it is possible for the additional receiver(s) to be horizontally displaced from their intended position relative to the source array. It is therefore not possible to tell whether apparent changes in the emitted wavefield arise from displacement of the additional receiver(s) from their intended position of vertically below the source array. This disadvantage is overcome by the present invention.

A further disadvantage of the prior art approach of providing one or more additional receivers below the source array is that a seismic source array is generally configured such that its output wavefield in the vertical direction is as consistent as possible—so that the output in the vertical direction is relatively insensitive to faults in the source array. This disadvantage is also overcome by the present invention.

The results of monitoring the seismic source array may be used to allow operation of the source array to be adjusted, if this should be necessary. Additionally or alternatively, processing of seismic data acquired at the receiver may take account of the results of monitoring the seismic source array.

The method may comprise obtaining information about the operation and/or positions of the source array and/or the receiver from the result of comparing the predicted far-field signature at the receiver location with seismic data acquired at the receiver. If the predicted far-field signature at the receiver location agrees with seismic data acquired at the receiver this suggests that the source array, the receiver, and any position determining systems associated with the source array and/or the receiver, are operating correctly. However, if the predicted far-field signature at the receiver location does not agree with seismic data acquired at the receiver this suggests that (at least) one of the source array, the receivers (near or far-field), and any position determining systems associated with the source array and/or the receiver, is not operating correctly—and the operator may then take corrective action.

Comparing the predicted far-field signature at the receiver locations with seismic data acquired at the receiver location(s) may comprise determining, for at least one receiver, the difference between the predicted far-field signature at the receiver location and seismic data acquired at the receiver.

Comparing the predicted far-field signature at the receiver locations with the seismic data acquired at the receiver location(s) may comprise determining, for at least one receiver, the difference between the predicted far-field signature at the receiver location and the direct arrival acquired at the receiver. In comparing the predicted far-field signature at the receiver locations with the seismic data acquired at the receiver location(s) it is necessary to take account of propagation effects (i.e., the fact that the waveform of a pulse of seismic energy changes as it propagates through a medium). The path of the direct arrival passes only through water, so that the expected waveform of the direct arrival is given by the convolution of the source signature with the known function describing propagation of signals from a point source through water in the presence of a free-surface—so that it is relatively straightforward to take account of propagation effects, as no knowledge of properties of the seabed and the medium below the seabed is required.

The method may further comprise predicting an error, for example as a function of temporal frequency, in the predicted far-field signature for another location from the difference between the predicted far-field signature at the receiver location and seismic data acquired at the receiver. The differences between the predicted far-field signature at a receiver location and seismic data acquired at the receiver can be analyzed as a function of time and/or as a function of frequency. It can be informative to look at the errors in prediction as function of frequency.

A second aspect of the invention provides a method comprising:
determining the difference between seismic data acquired at the receiver and a predicted far-field signature of the source array at the receiver location; and
estimating an error in the far-field signature predicted for another location from the determined difference between seismic data acquired at the receiver and the predicted far-field signature at the receiver location.

In an embodiment, estimating the error in the far-field signature predicted for the another location comprises adjusting the determined difference between the predicted far-field signature at the receiver location and seismic data acquired at the receiver for a difference in take-off direction between the another location and the receiver location.

The method may further comprise activating a seismic source array and acquiring seismic data at the receiver consequent to actuation of the source.

Other aspects of the invention provide corresponding computer-readable medium and apparatus.

### BRIEF DESCRIPTION OF THE DRAWINGS

Preferred embodiments of the present invention will be described by way of illustrative example, with reference to the accompanying figures in which:

FIG. 1 shows a comparison between a predicted incident wavefield and a measured incident wavefield;

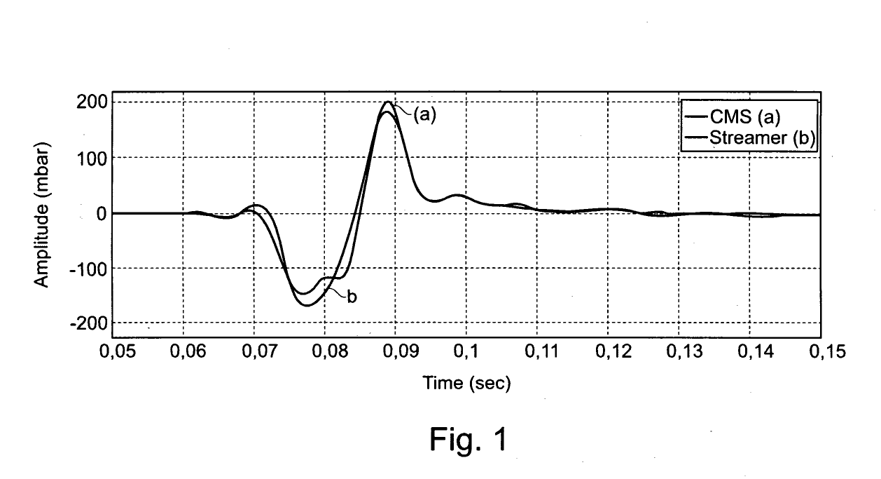

FIG. 2 illustrates propagation of a signature from an array of seismic sources;

FIG. 3 illustrates determination of a notional signature for an array of seismic sources;

FIG. 4 is a schematic side view of a prior art seismic surveying arrangement;

FIG. 5 is a schematic side view of a seismic surveying arrangement suitable for use with an embodiment of the present invention;

FIG. 6a is a block schematic flow diagram showing principal steps of a method according to one embodiment of the present invention;

FIG. 6b shows one of the steps of FIG. 6a in more detail; and

FIG. 7 is a schematic block diagram of an apparatus of an embodiment of the present invention.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE PREFERRED EMBODIMENT

The ensuing description provides preferred exemplary embodiment(s) only, and is not intended to limit the scope, applicability or configuration of the invention. Rather, the ensuing description of the preferred exemplary embodiment(s) will provide those skilled in the art with an enabling description for implementing a preferred exemplary embodiment of the invention. It being understood that various changes may be made in the function and arrangement of elements without departing from the scope of the invention as set forth in the appended claims.

Specific details are given in the following description to provide a thorough understanding of the embodiments. However, it will be understood by one of ordinary skill in the art that the embodiments maybe practiced without these specific details. For example, circuits may be shown in block diagrams in order not to obscure the embodiments in unnecessary detail. In other instances, well-known circuits, processes, algorithms, structures, and techniques may be shown without unnecessary detail in order to avoid obscuring the embodiments.

Also, it is noted that the embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in the figure. A process may correspond to a method, a function, a procedure, a subroutine, a subprogram, etc. When a process corresponds to a function, its termination corresponds to a return of the function to the calling function or the main function.

Moreover, as disclosed herein, the term “storage medium” may represent one or more devices for storing data, including read only memory (ROM), random access memory (RAM), magnetic RAM, core memory, magnetic disk storage mediums, optical storage mediums, flash memory devices and/or other machine readable mediums for storing information. The term “computer-readable medium” includes, but is not limited to portable or fixed storage devices, optical storage devices, wireless channels and various other mediums capable of storing, containing or carrying instruction(s) and/or data.

Furthermore, embodiments may be implemented by hardware, software, firmware, middleware, microcode, hardware description languages, or any combination thereof. When implemented in software, firmware, middleware or microcode, the program code or code segments to perform the necessary tasks may be stored in a machine readable medium such as storage medium. A processor(s) may perform the necessary tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, etc.

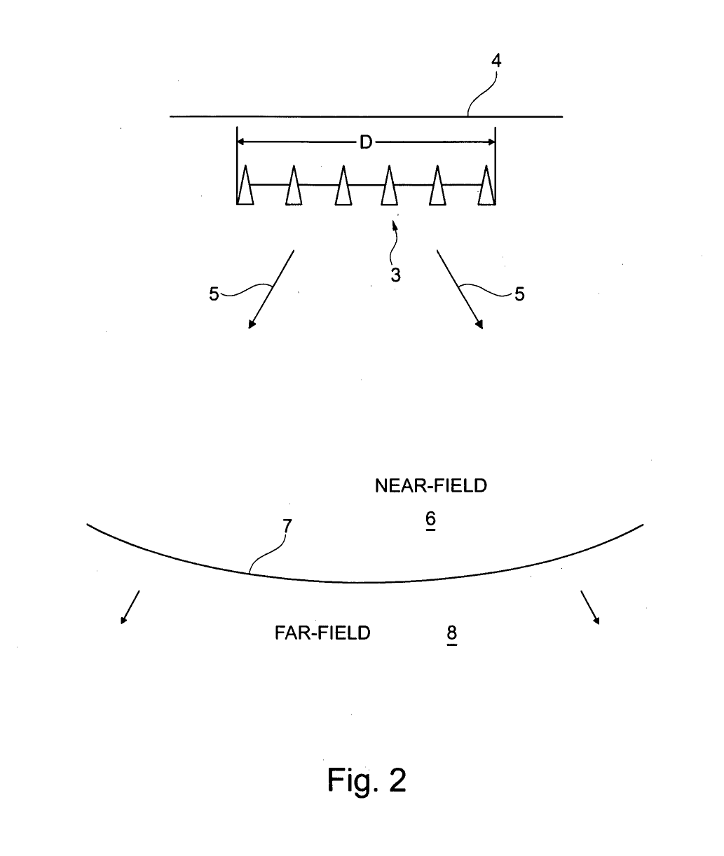

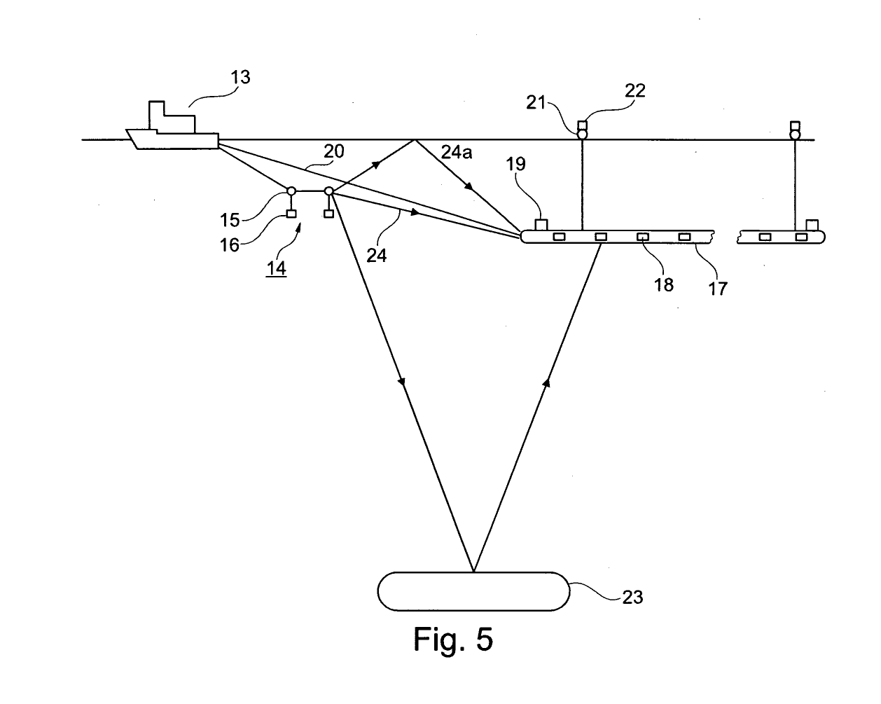

FIG. 5 is a side view of one form of typical marine seismic survey, known as a towed marine seismic survey. A seismic source array 14, containing one or more seismic sources 15, is towed by a survey vessel 13. The source array further comprises a one or more near-field sensors 16, for example a near-field hydrophone (NFH), one provided near each source 15 for measuring the near-field signature of the respective source. The/each near-field sensor(s) 16 is provided close to the (associated) source so as to be in the near field region 6 of FIG. 2.

The seismic survey further includes one or more receiver cables 17, with a plurality of seismic receivers 18 mounted on or in each receiver cable 17. FIG. 5 shows the receiver cables as towed by the same survey vessel 13 as the source array 14 via a suitable front-end arrangement 20, but in principle a second survey vessel could be used to tow the receiver cables 17. The receiver cables are intended to be towed through the water a few metres below the water-surface, and are often known as “seismic streamers”. A streamer may have a length of up to 5 km or greater, with receivers 18 being disposed every few metres along a streamer. A typical lateral separation (or “cross-line” separation) between neighbouring streamers in a typical towed marine seismic survey is of the order of 100 m.

Typically streamers are provided with one or more position determining systems for providing information about the positions, or relative positions, of the streamers 17. For example, the streamers may be provided with depth sensors 19 for measuring the depth of the streamer below the water surface. The streamers may additionally or alternatively be provided with sonic transceivers (not shown) for transmitting and receiving sonic or acoustic signals for monitoring the relative positions of streamers and sections of streamers. The streamers may alternatively or additionally be provided with a satellite-based positioning system, such as GPS, for monitoring the positions of the streamers—for example, compass measurements along the streamers may be used in combination with a few GPS measurements, usually at the front and the tail of the streamer. As an example FIG. 5 shows GPS receivers 22 mounted on floats 21 at the water surface above the streamer (FIG. 5 shows GPS receivers 22 mounted on the floats at the front and rear of the streamer).

One or more position determining systems (not shown) may also be provided on the source array to provide information about the position of the source array.

When one or more sources of the source array are actuated, they emit seismic energy into the water, and this propagates downwards into the earth's interior until it undergoes (partial) reflection by some geological feature 23 within the earth. The reflected seismic energy is detected by one or more of the receivers 19. In addition, when one or more sources of the source array are actuated some of the emitted seismic energy travels direct from the source array to the receivers 19 along path 24, and some travels along path 24a from the source array to the sea surface where it is reflected towards the receiver. The sum of the arrivals along paths 24 and 24a is called the ‘direct arrival’ in the water layer. (Raypath 24 would be the direct arrival for a ‘notional’ medium without a free surface interface (eg an air/water interface)).

The seismic surveying arrangement of FIG. 5 is generally conventional.

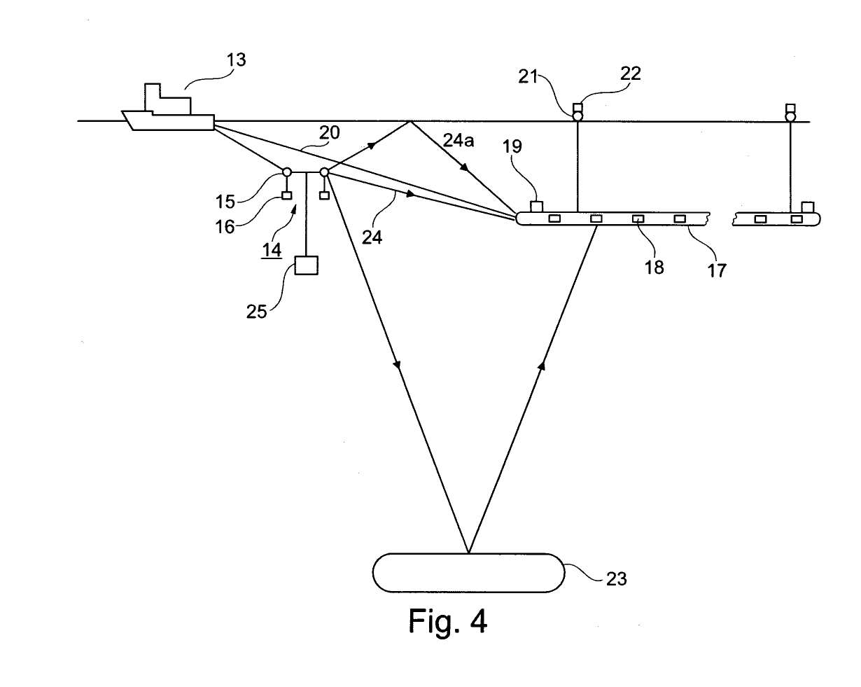

As mentioned above, it has been proposed to provide a seismic surveying arrangement such as the seismic surveying arrangement of FIG. 5 with one or more additional receivers positioned vertically below the source array to measure the output wavefield of the source array. This is shown in FIG. 4, which illustrates a seismic surveying arrangement generally similar to the seismic surveying arrangement of FIG. 5 but with one or more additional receivers 25 positioned vertically below the source array. The additional receivers 25 are provided solely to monitor the operation of the source array, and they do not contribute to providing information about the earth's interior. The inventors have however realised that it is not necessary to provide the additional receivers 25 of FIG. 4, and have proposed a method by which operation of the source array may be monitored effectively in a conventional seismic surveying arrangement such as that of FIG. 5.

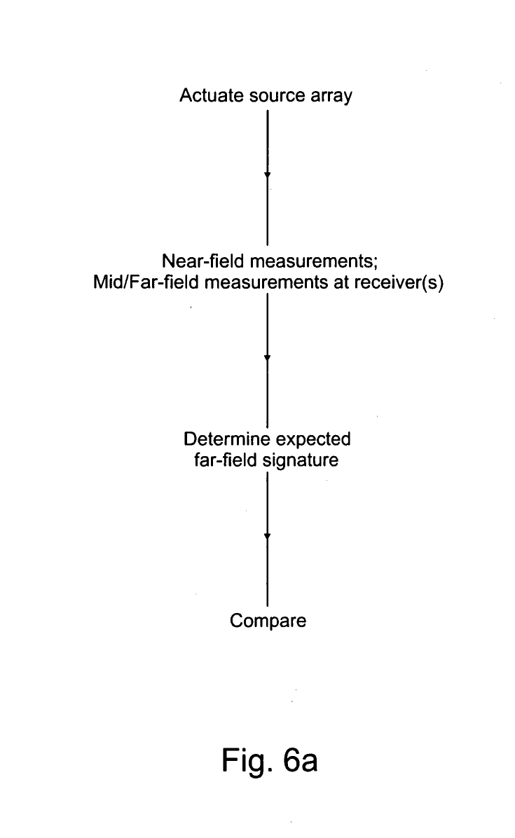

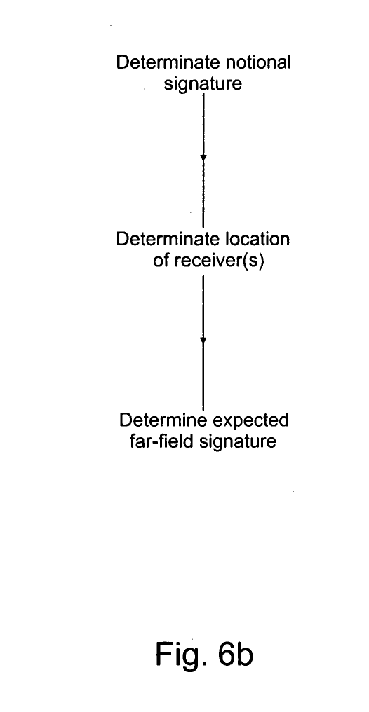

Note that features of the seismic recording system could be used to enhance the proposed workflow. For instance, when seismic data are recorded with over/under streamers, or with multi-component streamers, the streamers can be towed at a larger depth and/or closer to the source array, in order to provide an increased range of angles for the comparison step in FIG. 6a. When the distance between the sensors on the streamers and the source array is decreased, it may be necessary to make provisions for recording large amplitude signals without distortion (for example the dynamic range of the sensors may be exceeded, requiring different types of sensors in the front section of the streamer, or requiring attenuating the incoming signal by an analog device such as a capacitor in parallel with the sensor (as is available in the Q-marine streamers from WesternGeco).)

FIG. 6a illustrates a method according to one embodiment of the present invention. Initially, at step 1, the seismic source array 14 of the seismic surveying arrangement of FIG. 5 is actuated to emit seismic energy.

At step 2, near field measurements of the seismic energy emitted by the source array 14 consequent to its actuation are made by the near-field sensors 16 of the source array. Also consequent to actuation of the source array 14, other measurements (mid or far-field measurements) are made by the receivers 18 on the streamers 17 (the “mid-field” region is not shown in FIG. 2, but is at the boundary of the near-field region and the far-field region). The seismic energy incident on a receiver 18 will contain a number of “events”, each event corresponding to seismic energy travelling from the source array to the receiver along a different path. The “direct event”, corresponding to seismic energy that has travelled direct to the receiver along straight-line paths 24 and 24a, is normally the first event recorded at a receiver, as these paths have a shorter travel time than paths that involve reflection at a feature within the earth. In many cases the ‘direct arrival’ event will be easily separated from other events in the traces simply by the fact that the latest arriving energy associated with the ‘direct arrival’ is recorded earlier than energy propagating through the ground. Otherwise, when the direct arrival and other events interfere, any suitable method, for example as described in GB Patent No. 2 433 594 (above), may be applied to identify the direct arrival.

At step 3 of FIG. 6a, the expected far-field signature of the source at the location of one or more of the receivers 18 on/in the streamer 17. is calculated, from the measurements made by the near-field hydrophones 16 and from knowledge of the position of the receiver(s) relative to the source array 14. One way in which step 3 may be carried out is described in more detail in FIG. 6b below.

At step 4 of FIG. 6a, the expected far-field source signature calculated for the location of one or more of the receivers 18 in step 3 is compared with the seismic data acquired at the receiver(s), in particular with the direct arrival at the receiver(s). Since the path 24 of the direct arrival passes only through water, the expected waveform of the direct arrival is given by the convolution of the source signature with the known function describing propagation of signals from a point source through water.

If the expected far-field source signature calculated for the location of one or more of the receivers 18 in step 3 differs significantly from the actual far-field signature obtained from the direct arrival at the receivers, this indicates inconsistencies between the two measurements, due for instance to poor operation of the source array 14, to poor operation of the receiver array, or to inconsistent navigation data between the source and receiver measurements (so that the calculated relative positions of the source array and the receivers do not correspond to the true relative positions of the source array and the receivers). Conversely, if the actual far-field source signature agrees with the expected far-field signature, this indicates that the source and receiver arrays are operating correctly and that the navigation data are reliable.

Moreover, if the expected far-field source signature calculated for the location of one or more of the receivers disagree with the actual far-field signature obtained from the direct arrival at the receiver(s), it may be possible to obtain information about the likely cause from the manner in which the expected and actual far-field signatures disagree with one another. Thus, the results of the comparison may be used to obtain information about the operation of the source array and/or the receiver or to obtain information about the position of the source array relative to the receiver.

Since the components 24 and 24aof the direct arrival propagate only through water, using the direct arrival for the comparison between the predicted far-field signature at a receiver location and the seismic data acquired at that receiver location) has the advantage of relatively straightforward interpretation, where knowledge of medium properties below the water layer is not required. The prediction of the direct arrivals is typically done assuming constant water velocity and density and a flat sea surface. These assumptions are most often appropriate for the marine seismic applications, where the frequencies of interest are up to about 100 Hz. For higher frequencies, a more detailed model of the direct arrivals may be needed, including sea-surface shape estimates (as per U.S. Pat. No. 6,529,445 B1, Robert Laws, Mar. 4, 2003), and/or measurements of water velocity and density.

For example, when comparing the expected far-field source signature calculated for the location of one or more of the receivers with the actual far-field signature obtained from the direct arrival at the receiver(s), it may be found that the expected and actual signatures have similar wavelet shapes but a difference in arrival time. This would indicate inconsistency in position measurements between the source and the receivers—and the difference in arrival time may be converted to a distance error, using the speed of sound in water. This distance error represents the distance between the estimated distance from the source array to the receiver and the actual distance. This position information may be taken into account in subsequent processing of seismic data.

Another possible result when comparing the expected far-field source signature with the actual far-field signature is that there is good agreement at low frequencies, but increasing errors at high frequencies. This may indicate errors in the position measurements/estimates for the source array.

Another possible result when comparing the expected far-field source signature with the actual far-field signature is that there is poor agreement at all frequencies, and differences in amplitude and shape between the expected wavelet and the actual wavelet. This may point to problems with the source array. The operator should double-check with other quality-control indicators for the source array, for example to check for: timing delays between guns, incorrect pressure of supply of air to the guns, whether some guns are not firing. If incorrect operation of the source array is found, the operator may adjust operation of the source array as necessary.

The operator may apply one or more thresholds for the comparison, and disregard any differences less than the thresholds. For example, the operator may place a threshold on the difference between the expected arrival time and the actual arrival time, and/or on the amplitude difference.

The method of the invention may be carried out in real-time or in near-real time, so that the survey operators are alerted of any possible problem very soon after the source array has been actuated. They are able to investigate and, if necessary, take corrective action such as, for example, replacing or repairing a malfunctioning source, a malfunctioning receiver or a malfunctioning position determining system (either on the source array or on the streamer), or suspending data acquisition until the fault has been rectified.

In the method of the present invention, the notional signatures of the sources are calculated from the measurements made by the near-field sensors 16 when the sources are actuated to fire a shot, and the data acquired at the receivers are also obtained for that shot. Thus, any variations in the output of the source array from one shot to another do not affect the accuracy of the comparison.

If the expected far-field source signature calculated for the location of one or more of the receivers 18 in step 3 agrees (to within some chosen limit) with the actual far-field signature obtained from the direct arrival at the receivers, this provides confirmation that the source array is operating correctly. In this case, the seismic data acquired at the receivers 18 may undergo further processing to obtain information about the earth's geological structure, for example to obtain information about a parameter of the earth's interior or to locate and/or characterise a hydrocarbon reservoir within the earth. The seismic data may be processed using any suitable processing steps, and the further processing of the seismic data will not be described in detail.

Step 4 of FIG. 6a may comprise determining whether the difference between the expected far-field source signature calculated for the location of one or more of the receivers 18 in step 3 and the seismic data acquired at those receivers is below a threshold. The threshold may be expressed either as a proportion of the expected value or as an absolute value.

It should be noted that FIG. 6a shows only the principal steps of the invention, and that a method of the invention may include further steps. As an example, the data acquired at the receivers 18 may undergo preliminary processing, for example to reduce or eliminate noise in the data, before the data are compared with the expected far-field source signature.

The present invention provides a number of advantages over the prior art seismic surveying arrangement of FIG. 4 in which additional receivers 25 are provided below the source array. A first advantage is that the need to provide the additional receivers 25 in the seismic surveying arrangement of FIG. 4 is eliminated in the present invention. The present invention uses measurements made by the near-field hydrophones 16 to determine the signature of the source array, but conventional source arrays in use today generally include near-field hydrophones or other near field sensors. The method of the invention may be used with any source array that includes near-field hydrophones or other near field sensors, and there is no need to modify the source array.

In the prior art seismic surveying arrangement of FIG. 4 it is assumed that the additional receiver(s) 25 are positioned vertically below the source array 14. However this assumption may be incorrect, since the additional receivers are usually suspended in the water and so are able to move freely in the horizontal plane, for example as a result of the action of tides and/or currents. Any movement of additional receiver(s) 25 relative to the sources 15 may affect the accuracy with which the notional signatures of the sources can be estimated, since the position of the additional receiver(s) 25 relative to the sources 15 is used in the estimation of the notional signatures. In the present invention however measurements made by the near-field hydrophones 16 are used to determine the signature of the source array, and the positions of the near-field hydrophones 16 relative to the positions of the sources 15 are know with good accuracy. Furthermore, in the method of the present invention it is possible to determine the positions of the receivers 18 relative to the source array 14 with high accuracy, using the position-determining systems that are now conventionally provided in a towed marine receiver array. Additionally, it may be possible to steer the positions of the receivers, using control equipment (such as Q-fins) as available in Q-marine systems. The source signature at the receiver positions can therefore be reliably estimated. The comparison between the expected source signature at a receiver location and the measured signal at the receiver can thus be made reliably.

A further disadvantage of the prior art approach of FIG. 4 of providing one or more additional receivers 25 below the source array 14 is that it is generally the case that a seismic source array is configured such that its output wavefield in the vertical direction is as consistent as possible. In the present invention however, the receivers 18 are towed behind the source array, and the direct path 24 from the source array 14 to the receivers 18 has a take-off angle of almost 90° (and would typically be 80° or more). The present invention is therefore much more sensitive to faults or errors in the operation of the source array, because it is not monitoring the source array along the direction where the source array is configured to have as consistent an output as possible.

The method of FIG. 6a may be repeated for each shot, to allow the source array to be monitored continuously, or it may be repeated at intervals, for example after every 10 shots.

FIG. 6b is a schematic flow diagram that shows one way in which step 3 of the method of FIG. 6a may be carried out.

Initially, at step 1, the notional signatures of the sources 15 of the source array 14 are determined from the near-field measurements of the seismic energy emitted by the source array in step 2 of FIG. 6a. Generally, this will result in the determination of a respective notional signature for each source of the source array (or a respective notional signature for each source of the source array that was actuated if one or more sources of the array were not actuated in the shot). The notional signature of the sources may be determined by, for example, the method of U.S. Pat. No. 4,476,553 or GB 2 433 594, the contents of both documents being hereby incorporated by reference. To apply the method of U.S. Pat. No. 4,476,553, for example, it would be necessary for there to be near-field measurements at n different locations, where n is the number of sources of the array.

At step 2, the positions of one or more of the receivers 18 on the streamer 17, relative to the source array, are determined. The positions may be determined from the position information provided by position-determining systems on the receiver array (such as the GPS receivers 22 in FIG. 5), and from information about the position of the tow vessel 13 and/or the source array.

Preferably, step 2 also determines the orientation of the source array. The output of a seismic source array is generally not isotropic so, in order accurately to estimate the far-field signature at a receiver location, it is desirable to know how the source array is oriented as well as knowing the position of the receiver relative to the source array.

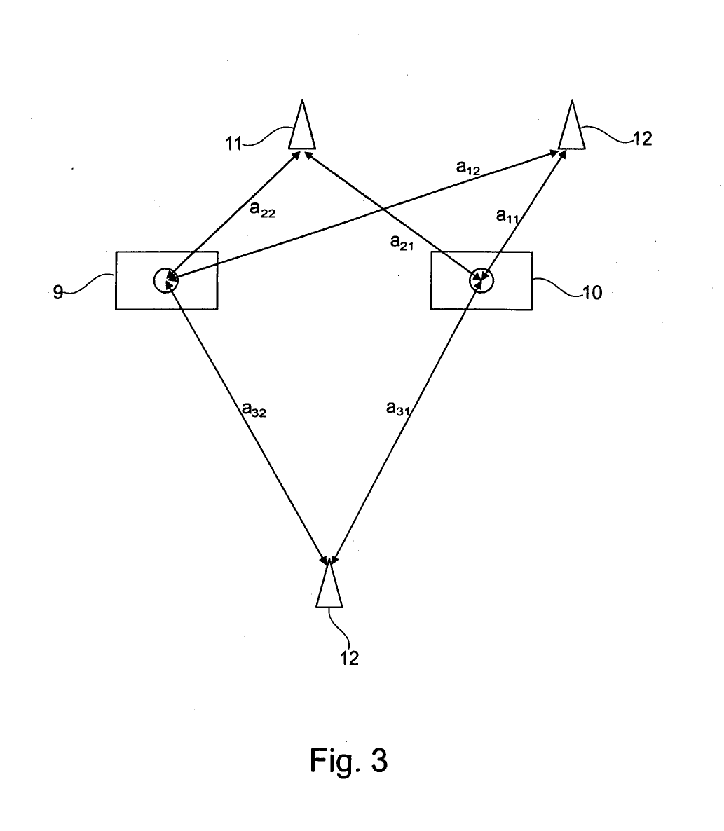

At step 3, the expected far-field signature at the locations of one or more of the receivers are estimated, from the notional signatures obtained in step 1 and from the relative positions, and possibly orientation of the source array, obtained in step 2. This may be carried out as explained above with regard to FIG. 3.

A further feature of the present invention is that it enables an estimate to be made of the error in the estimation of the far-field signature at any desired location, for example at a point directly below the source array. As explained above, the far-field signature at any desired location may be estimated once the notional signatures of the sources of the source array have been determined—but any errors in the estimation of the notional signatures of the sources will lead to errors in the estimation of the far-field signature.

In the present invention, the comparison of the expected far-field signature at the locations of one or more of the receivers with the data actually acquired at the receiver(s) provides a quantitative indication of the error in the estimation of the far-field signature at the receiver location(s); any discrepancy between the expected far-field signature and the data actually acquired and suitably pre-processed as described above with reference to FIG. 6a at one of the receivers 18 is essentially due to error in the estimation of the far-field signature. Moreover, the differences between the expected far-field signature at a receiver location and seismic data acquired at the receiver can be analyzed as a function of time and/or as a function of frequency. It can be informative to look at the errors in prediction as function of frequency.

The error in the estimation of the far-field signature will be dependent on the take-off direction. For the case in which two take-off directions have the same angle in a horizontal plane (eg the same azimuth) and differ only in take-off angle (that is, the two take-off directions lie in a common vertical plane), the comparison of the expected far-field signature at the location of one of the receivers with the data actually acquired at that receiver is a measure of the error in the estimation of the far-field signature at the take-off angle of that receiver, that is E₁ where E₁ denotes the error at a first location which has take-off angle θ1 . The estimated error E₂ in the estimation of the far-field signature for a second location with a different take-off angle, θ2 where θ2≠θ1, may be found from the error E₁, by adjusting the error to take account of the different take-off angle. Simulations of prediction errors have been made which show how these errors vary with take-off direction from the source array and frequency content of the signal, as described in, for example, co-pending U.K. patent application No. ______ filed on the same day as this application, entitled “Processing Seismic Data”, temporarily referenced herewith by its attorney docket number 57.0913 GB NP, the contents of which are hereby incorporated by reference. These may be used to provide scaling factors that enable the likely error E₂ in the estimated far-field signature for the second location to be estimated, with take-off angle θ2, to be obtained by suitably scaling the error E₁ determined from step 4 of FIG. 6a for a receiver at a first location having a take-off angle θ1.

In the general case, the take-off direction to one location may have a different heading and/or a different take-off angle from the take-off direction to another location. In order to estimate the likely error E₂ in the estimated far-field signature for a second location, the error E₁ determined at one location must be scaled for a change in heading and/or for a change in take-off angle between the two locations, as appropriate.

The scaling may for example be performed using a suitable look-up table, computed from simulations.

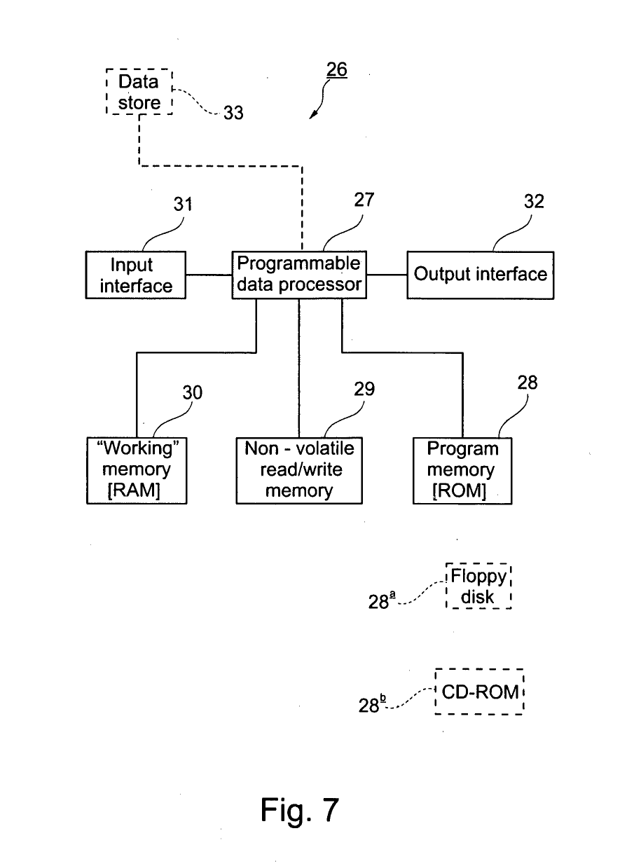

FIG. 7 is a schematic block diagram of a programmable apparatus 26 according to the present invention. The apparatus comprises a programmable data processor 27 with a program memory 28, for instance in the form of a read-only memory (ROM), storing a program for controlling the data processor 27 to perform any of the processing methods described above. The apparatus further comprises non-volatile read/write memory 29 for storing, for example, any data which must be retained in the absence of power supply. A “working” or scratch pad memory for the data processor is provided by a random access memory (RAM) 30. An input interface 31 is provided, for instance for receiving commands and data. An output interface 32 is provided, for instance for displaying information relating to the progress and result of the method. Seismic data for processing may be supplied via the input interface 32, or may alternatively be retrieved from a machine-readable data store 33.

The program for operating the system and for performing a method as described hereinbefore is stored in the program memory 28, which may be embodied as a semi-conductor memory, for instance of the well-known ROM type. However, the program may be stored in any other suitable storage medium, such as magnetic data carrier 28a, such as a “floppy disk” or CD-ROM 28b.

The invention has been described above with reference to a seismic surveying arrangement in which the receivers are provided on/in towed marine seismic streamers. The invention is not however limited to this and may, for example, be carried out with a seismic surveying arrangement in which the receivers are provided on/in seabed seismic cable, or seabed nodes.

Where the invention is applied with a towed marine seismic surveying arrangement, the invention may in principle be used with any towed marine seismic surveying arrangement having the general form shown in FIG. 5. However, it should be noted that systems with the following characteristics are strongly preferred for use with the invention:
point receivers (that is, where the signal acquired at each receiver is recorded and processed individually): If only group-formed signals are recorded at the receiver array, then the method of FIG. 6b would preferably simulate a group-formed measurement, for consistency with the measurements made at the receivers (and in a particularly advantageous embodiment the method of FIG. 6b is able to simulate either a point receiver measurement or a group-formed measurement, depending on whether point receivers or group-formed receivers were used).
densely spaced receivers—this is useful for removing swell noise from the receiver array.

These features are found in the Q-marine systems from WesternGeco.

While the principles of the disclosure have been described above in connection with specific apparatuses and methods, it is to be clearly understood that this description is made only by way of example and not as limitation on the scope of the invention.

1. A method of monitoring a marine seismic source array, comprising:
a) consequent to actuation of the seismic source array, (i) measuring seismic energy emitted by the source array, using at least one near field sensor and (ii) acquiring seismic data using at least one seismic receiver;
b) predicting the far-field signature of the source array at one or more of the receiver location(s) from the seismic energy measured by the near-field sensor(s); and
c) for one or more of the receivers, comparing the predicted far-field signature at the receiver location with seismic data acquired at the receiver.

2. A method as claimed in claim 1 wherein predicting the far-field signature of the source array at the receiver location(s) comprises determining notional signatures for sources of the seismic source array from the seismic energy measured by the near field sensor(s).

3. A method as claimed in claim 2 and further comprising determining, from the notional signatures of the sources, the expected far-field signature of the source array at the receiver location(s).

4. A method as claimed in claim 1 and further comprising actuating the seismic source array to emit seismic energy.

5. A method as claimed in claim 1 wherein comparing the predicted far-field signature at the receiver locations with seismic data acquired at the receiver location(s) comprises determining, for at least one receiver, the difference between the predicted far-field signature at the receiver location and seismic data acquired at the receiver.

6. A method as claimed in claim 5 wherein comparing the predicted far-field signature at the receiver locations with the seismic data acquired at the receiver location(s) comprises determining, for at least one receiver, the difference between the predicted far-field signature at the receiver location and the direct arrival acquired at the receiver.

7. A method as claimed in claim 5 and further comprising predicting an error in the predicted far-field signature for another location from the difference between the predicted far-field signature at the receiver location and seismic data acquired at the receiver.

8. A method as claimed in claim 7, wherein predicting the error in the predicted far-field signature for the another location comprises adjusting the difference between the predicted far-field signature at the receiver location and the seismic data acquired at the receiver for a difference in take-off direction between the another location and the receiver location.

9. A method as claimed in claim 1 and comprising obtaining information about the operation of the source array and/or the receiver from the result of comparing the predicted far-field signature at the receiver location with seismic data acquired at the receiver.

10. A method as claimed in claim 1 and comprising obtaining information about the position of the source array relative to the receiver from the result of comparing the predicted far-field signature at the receiver location with seismic data acquired at the receiver.

11. A method comprising:
a) activating a seismic source array and acquiring seismic data at a receiver;
b) determining the difference between seismic data acquired at the receiver and a predicted far-field signature of the source array at the receiver location; and
c) estimating an error in the far-field signature predicted for another location from the determined difference between seismic data acquired at the receiver and the predicted far-field signature at the receiver location.

12. A method as claimed in claim 10 wherein estimating the error in the far-field signature predicted for the another location comprises adjusting the determined difference between the predicted far-field signature at the receiver location and seismic data acquired at the receiver for a difference in take-off direction between the another location and the receiver location.

13. A method as claimed in claim 11 and comprising predicting the far-field signature of the seismic source array at the receiver location.

14. A method as claimed in claim 13 wherein predicting the far-field signature of the seismic source at the receiver location comprises predicting the far-field signature of the seismic source from notional signatures of the sources of the source array.

15. A method as claimed in claim 14 and comprising acquiring data at least n near-field sensors upon actuation of the seismic source array, where the source array comprises n sources; and determining the notional signatures of the source from data acquired at the near-field sensors.

16. A computer-readable medium containing instructions that, when executed on a processor, perform a method of monitoring a seismic source array comprising:
a) consequent to actuation of the seismic source array, (i) measuring seismic energy emitted by the source array, using at least one near field sensor and (ii) acquiring seismic data using at least one seismic receiver;
b) predicting the far-field signature of the source array at one or more of the receiver location(s) from the seismic energy measured by the near-field sensor(s); and
c) for one or more of the receivers, comparing the predicted far-field signature at the receiver location with seismic data acquired at the receiver.

17. A computer-readable medium containing instructions that, when executed on a processor, perform a method comprising:
determining the difference between seismic data acquired at the receiver and a predicted far-field signature of the source array at the receiver location; and
estimating an error in the far-field signature predicted for another location from the determined difference between seismic data acquired at the receiver and the predicted far-field signature at the receiver location.

18. An apparatus for monitoring a marine seismic source array, comprising:
one or more near-field sensors for measuring seismic energy emitted by a source array consequent to actuation of the seismic source array,
one or more seismic receivers for measuring seismic energy emitted by the source array,
means for predicting the far-field signature of the source array at one or more of the receiver location(s) from the seismic energy measured by the near-field sensor(s); and
means for comparing, for one or more of the receivers, the predicted far-field signature at the receiver location with seismic data acquired at the receiver.

19. An apparatus for processing seismic data comprising:
means for determining the difference between seismic data acquired at the receiver and a predicted far-field signature of the source array at the receiver location; and
means for estimating an error in the far-field signature predicted for another location from the determined difference between seismic data acquired at the receiver and the predicted far-field signature at the receiver location.
